(19) United States
(12) Patent Application Publication
(10) Pub. No.: US 2020/0024402 A1
(43) Pub. Date: Jan. 23, 2020

(54) METHOD FOR PRODUCING GRANULAR POLYARYLENE SULFIDE AND GRANULAR POLYARYLENE SULFIDE

(71) Applicant: Kureha Corporation, Tokyo (JP)

(72) Inventors: Akihiro KONNO, Tokyo (JP); Ken-ichi TAKAKI, Tokyo (JP)

(21) Appl. No.: 16/481,721

(22) PCT Filed: Feb. 5, 2018
(86) PCT No.: PCT/JP2018/003845

§ 371 Date: Jul. 29, 2019

(30) Foreign Application Priority Data
Feb. 7, 2017 (JP) 2017-020743

(51) Int. Cl. C08G 75/0209; C08G 75/0254

(52) U.S. Cl. CPC C08G 75/0209; C08G 75/0254

(57) ABSTRACT

To provide a method for producing granular polyarylene sulfide (hereinafter, PAS), the method capable of providing granular PAS having high particle strength and low melt viscosity in high yield without using special additives and the like; and granular PAS.

A method according to the present invention is a method for producing granular PAS having a melt viscosity of from 1 to 30 Pa.s, which is measured at a temperature of 310° C. and a shear rate of 1216/s, by polymerizing a sulfur source and a dihalo aromatic compound in an organic amide solvent.

### TECHNICAL FIELD

The present invention relates to a method for producing granular polyarylene sulfide and granular polyarylene sulfide.

### BACKGROUND ART

Polyarylene sulfide (hereinafter, abbreviated as “PAS”) represented by polyphenylene sulfide (hereinafter, abbreviated as “PPS”) is engineering plastic which is excellent in heat resistance, chemical resistance, flame retardancy, mechanical strength, electrical characteristics, dimensional stability, and the like. PAS has been widely used in a wide variety of fields, such as electric/electronic devices and devices for automobiles, because PAS can be formed into various molded products, films, sheets, fibers, and the like by ordinary melt processing methods, such as extrusion molding, injection molding, and compression molding.

From the perspective of fluidity at the time of molding, PAS having high fluidity, that is, low melt viscosity is required, and is under development. For example, Patent Document 1 discloses a method for producing granular PPS, the method capable of providing granular PPS having a low melt viscosity of 16 Pa·s.

### CITATION LIST

### Patent Document

Patent Document 1: JP 07-010997 A

### SUMMARY OF INVENTION

### Technical Problem

However, the granular PAS obtained by the known production method has low particle strength, and thus there is a problem that the granular PAS is pulverized in the recovery step and the yield is lowered.

The present invention has been made in view of the above problem, and an object of the present invention is to provide a method for producing granular PAS, the method capable of providing granular PAS having high particle strength and low melt viscosity in high yield without using special additives and the like; and granular PAS.

### Solution to Problem

The present inventors have found that the above object is achieved by sequentially performing a first polymerization step, a phase separation agent addition step, a second polymerization step, and a cooling step at the time of the production of the granular PAS, setting a molar ratio of water with respect to an organic amide solvent to from 0.6 to 3.0 in the phase separation agent addition step, and setting a cooling rate to 0.5° C./min or less in the cooling step. Thus, the present invention has been completed.

A method for producing granular PAS according to the present invention is a method for producing granular PAS having a melt viscosity of from 1 to 30 Pa·s, which is measured at a temperature of 310° C. and a shear rate of 1216 sec⁻¹, by polymerizing a sulfur source and a dihalo aromatic compound in an organic amide solvent, the method including:

a first polymerization step of initiating a polymerization reaction by heating a mixture containing the organic amide solvent, the sulfur source, water, the dihalo aromatic compound, and an alkali metal hydroxide and generating a reaction mixture containing a prepolymer having a conversion rate of the dihalo aromatic compound of from 50 to 98 mol %;

a phase separation agent addition step of adding a phase separation agent to the reaction mixture after the first polymerization step;

a second polymerization step of continuing the polymerization reaction after the phase separation agent addition step; and

a cooling step of cooling the reaction mixture after the second polymerization step,

in which the phase separation agent includes water;

a molar ratio of water with respect to the organic amide solvent in the phase separation agent addition step is from 0.6 to 3.0;

the polymerization reaction in the second polymerization step is performed in a range of from 245 to 290° C.; and the cooling rate in the cooling step is 0.5° C./min or less.

In the method for producing granular PAS according to the present invention, a pH of the reaction mixture after the second polymerization step is preferably set to from 8 to 11.

In the method for producing granular PAS according to the present invention, the phase separation agent is preferably a mixture containing an alkali metal carboxylate and water.

The granular PAS according to the present invention is obtained by the above method and has an average particle size of from 200 to 5000 μm and a particle strength of 50% or more.

### Advantageous Effects of Invention

According to the present invention, it is possible to provide a method for producing granular PAS, the method capable of providing granular PAS having high particle strength and low melt viscosity in high yield without using special additives and the like; and granular PAS.

### DESCRIPTION OF EMBODIMENTS

### I. Method for Producing Granular PAS

An embodiment of a method for producing granular PAS according to the present invention will be described below. The method for producing granular PAS in the present embodiment includes, as main steps, a first polymerization step, a phase separation agent addition step, a second polymerization step, and a cooling step. In addition, as desired, the method for producing granular PAS may include a preparation step, a dehydration step, and a post-treatment step.

Among these steps, the phase separation agent addition step is performed by setting a molar ratio of water with respect to an organic amide solvent to from 0.6 to 3.0. In addition, the cooling step is performed at a cooling rate of 0.5° C/min or less. Each of the steps is described in detail below.

### Dehydration Step

The dehydration step is a step of discharging a distillate containing water from the reaction system containing a mixture containing the organic amide solvent and the sulfur source to the outside of the reaction system at the time of polymerization reaction, prior to the preparation step.

The polymerization reaction of the sulfur source and the dihalo aromatic compound is affected, e.g. promoted or inhibited, by the amount of water present in the polymerization reaction system. Therefore, the dehydration step is not necessary as long as the water content does not inhibit the polymerization reaction; however, the water content of the polymerization reaction system is preferably reduced by performing the dehydration step before the polymerization.

In the dehydration step, the dehydration is preferably performed by heating in an inert gas atmosphere. The dehydration step is performed in a reaction vessel, and the distillate containing water is discharged outside the reaction vessel. Water to be dehydrated in the dehydration step includes hydrated water contained in the raw materials charged in the dehydration step, an aqueous medium of the aqueous mixture, and water produced as a byproduct by a reaction between the raw materials.

The heating temperature in the dehydration step is not limited as long as the heating temperature is 300° C. or lower but is preferably from 100 to 250° C. The heating time is preferably from 15 minutes to 24 hours and more preferably from 30 minutes to 10 hours.

In the dehydration step, the dehydration is performed until the water content reaches a predetermined range. That is, in the dehydration step, it is preferable to perform the dehydration until the water content is preferably from 0.5 to 2.4 mol with respect to 1.0 mol of sulfur source (hereinafter, also referred to as “prepared sulfur source” or “effective sulfur source”) in a prepared mixture (described later). When the water content is too small in the dehydration step, the water content needs to be adjusted to a desired content by adding water in the preparation step performed before the polymerization step.

### Preparation Step

The preparation step is a step of preparing a mixture containing the organic amide solvent, the sulfur source, water, and the dihalo aromatic compound. The mixture prepared in the preparation step is also referred to as “prepared mixture”.

In the case where the dehydration step is performed, the amount of prepared sulfur source (effective sulfur source) can be calculated by subtracting the molar amount of hydrogen sulfide volatilized in the dehydration step from the molar amount of sulfur source charged in the dehydration step.

In the case where the dehydration step is performed, as necessary, in the preparation step, an alkali metal hydroxide and water can be added to the mixture remaining in the system after the dehydration step.

In the preparation step, a prepared mixture containing preferably from 0.95 to 1.2 mol, and more preferably from 1 to 1.09 mol, of the dihalo aromatic compound per 1 mol of the sulfur source is prepared.

Note that, as the organic amide solvent, the sulfur source, the dihalo aromatic compound, and the alkali metal hydroxide, those typically used in production of PAS can be used. Examples of the organic amide solvent include amide compounds, such as N,N-dimethylformamide and N,N-dimethylacetamide; N-alkylcaprolactam compounds, such as N-methyl-ε-caprolactam; N-alkylpyrrolidone compounds or N-cycloalkylpyrrolidone compounds, such as N-methyl-2-pyrrolidone (NMP) and N-cyclohexyl-2-pyrrolidone; N,N-dialkylimidazolidinone compounds, such as 1,3-dialkyl-2-imidazolidinone; tetraalkyl urea compounds, such as tetramethyl urea; and hexaalkylphosphate triamide compounds, such as hexamethyl phosphate triamide.

Examples of the sulfur source include alkali metal sulfide, alkali metal hydrosulfide, and hydrogen sulfide. Examples of the alkali metal sulfide include sodium sulfide, lithium sulfide, potassium sulfide, rubidium sulfide, and cesium sulfide.

Examples of the alkali metal hydrosulfides include lithium hydrosulfide, sodium hydrosulfide, potassium hydrosulfide, rubidium hydrosulfide, and cesium hydrosulfide.

Examples of the dihalo aromatic compounds include o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide, and dihalodiphenyl ketone. A halogen atom refers to each atom of fluorine, chlorine, bromine, and iodine, and the two halogen atoms in the dihalo aromatic compound may be the same or different.

As the alkali metal hydroxide, lithium hydroxide, sodium hydroxide, potassium hydroxide, rubidium hydroxide, and cesium hydroxide can be used.

These materials may be used alone or may be used by mixing two or more types as long as the combination can produce the PAS.

### First Polymerization Step

A first polymerization step is a step of initiating a polymerization reaction by heating a mixture containing the organic amide solvent, the sulfur source, water, the dihalo aromatic compound, and the alkali metal hydroxide and generating a reaction mixture containing a prepolymer having a conversion rate of the dihalo aromatic compound of from 50 to 98 mol %. In the first polymerization step, the polymerization reaction is performed in the reaction system in which a polymer to be produced is uniformly dissolved in the organic amide solvent. In the present specification, a reaction mixture means a mixture containing a reaction product generated by the above-mentioned polymerization reaction and starts to be generated simultaneously with the initiation of the polymerization reaction.

To shorten the polymerization cycle time, the polymerization reaction method may be a method that uses two or more reaction vessels.

In the first polymerization step, preferably, the polymerization reaction is initiated by heating the mixture prepared in the preparation step, that is, the prepared mixture to a temperature of from 170 to 270° C. to generate the prepolymer having the conversion rate of the dihalo aromatic compound of from 50 to 98 mol %. The polymerization temperature in the first polymerization step is preferably selected from the range of from 180 to 265° C. in order to suppress a side reaction or a decomposition reaction.

The conversion rate of the dihalo aromatic compound is preferably from 60 to 97%, more preferably from 65 to 96%, and still more preferably from 70 to 95%. The conversion ratio of the dihalo aromatic compound can be calculated by determining the amount of the dihalo aromatic compound remaining in the reaction mixture by gas chromatography and then performing a calculation based on the remaining amount of the dihalo aromatic compound, the prepared amount of the dihalo aromatic compound, and the prepared amount of the sulfur source.

During the polymerization reaction, the amount of at least one of water and the organic amide solvent may be changed. For example, water can be added to the reaction system during the polymerization. However, in the first polymerization step, usually, it is preferable to initiate the polymerization reaction using the mixture prepared in the preparation step and to end the reaction in the first polymerization step.

At the time of the initiation of the first polymerization step, the water content is preferably from 0.5 to 2.4 mol, more preferably from 0.5 to 2.0 mol, and still more preferably from 1.0 to 1.5 mol, per 1.0 mol of the sulfur source. The water content in the above range at the time of the initiation of the first polymerization step allows the sulfur source to be solubilized in the organic amide solvent and allows the reaction to be favorably advanced.

### Phase Separation Agent Addition Step

The phase separation agent addition step is a step of adding a phase separation agent to the reaction mixture after the first polymerization step. The phase separation agent is not particularly limited as long as it contains water.

As the phase separation agent other than water, at least one type selected from the group consisting of organic carboxylic acid metal salts, organic sulfonic acid metal salts, alkali metal halides, alkaline earth metal halides, phosphoric acid alkali metal salts, alcohols, and paraffinic hydrocarbons can be used. Among these, water is preferable because of low cost and ease in post- treatment. In addition, a combination of an organic carboxylate and water, in particular, a mixture containing an alkali metal carboxylate such as sodium acetate and water is preferred. The salts may be in forms obtained by separately adding corresponding acids and bases.

The amount of the phase separation agent to be used varies depending on the type of compounds used but is usually in the range of from 1 to 10 mol with respect to 1 kg of the organic amide solvent. In particular, a method for adding water as the phase separation agent in the phase separation agent addition step is preferably adopted so that the water content in the reaction system in the second polymerization step exceeds 4 mol and is 20 mol or less per 1 kg of organic amide solvent. In the present invention, the phase separation agent contains water, and the molar ratio of water with respect to the organic amide solvent in the phase separation agent addition step is from 0.6 to 3.0, and preferably from 0.7 to 2.0, and more preferably from 0.8 to 1.5 from the perspective of the particle strength. The amount of the phase separation agent to be used in the above range allows the production of the PAS particle having high particle strength in a high yield.

In the case where a mixture containing an alkali metal carboxylate such as sodium acetate and water is used as the phase separation agent, the amount of the mixture to be used is preferably adjusted so that the amount of the alkali metal carboxylate is 30 mol or less per 1 mol of the sulfur source. The method for adding a phase separation agent according to the present embodiment is not particularly limited, and examples thereof include a method for adding the total amount of the phase separation agent at one time and a method for adding a phase separation agent a plurality of times.

### Second Polymerization Step

The second polymerization step is a step of continuing the polymerization reaction after the phase separation agent addition step. In the second polymerization step, phase separation polymerization is performed in which the polymerization reaction is continued in the presence of the phase separation agent and in the state where the reaction system is phase-separated into a concentrated polymer phase and a dilute polymer phase. Specifically, adding a phase separation agent allows the polymerization reaction system (polymerization reaction mixture) to be phase-separated into the concentrated polymer phase (phase mainly containing dissolved PAS) and the dilute polymer phase (phase mainly containing organic amide solvent). The phase separation agent may be added at the beginning of the second polymerization step, or the phase separation agent may be added during the second polymerization step to cause the phase separation on the way.

The polymerization temperature in the second polymerization step is heated to from 245 to 290° C., preferably from 250 to 285° C., and more preferably from 255 to 280° C. to continue the polymerization reaction. The polymerization temperature may be maintained at a fixed temperature or may be increased or decreased stepwise as necessary. The temperature is preferably maintained at a fixed temperature from the perspective of controlling the polymerization reaction. The polymerization reaction time is typically in the range of from 10 minutes to 72 hours and preferably from 30 minutes to 48 hours.

From the perspective of the improvement in yield, the pH of the reaction mixture after the second polymerization step is preferably from 8 to 11 and more preferably from 9 to 10.5. The method for adjusting the pH of a reaction mixture is not particularly limited, and examples thereof include a method for adjusting the content of alkali metal hydroxide in the preparation step, a method for adding alkali metal hydroxide, inorganic acid, and/or organic acid later, or the like.

### Cooling Step

The cooling step is a step of cooling the reaction mixture after the second polymerization step. In the cooling step, the reaction mixture is cooled to 200° C., for example.

In the cooling step, the liquid phase containing the generated polymer is cooled. In the cooling step, the liquid phase is not rapidly cooled, by flash of the solvent and the like, but the liquid phase is slowly cooled at a cooling rate of 0.5° C./min or less, so that the particle strength of the granular PAS having a melt velocity of from 1 to 30 Pa. s measured at a temperature of 310° C. and a shear rate of 1216 sec⁻¹ can be effectively improved. The cooling rate is preferably 0.4° C./min or less and more preferably 0.35° C./min or less, from the perspective that the particle strength of the granular PAS is easily improved.

The slow cooling can be performed by a method for exposing a polymerization reaction system to ambient temperature (for example, room temperature). In order to control the cooling rate of the liquid phase, it is also possible to employ a method for making a refrigerant flow in a jacket of a polymerization reaction vessel or refluxing a liquid phase with a reflux condenser. Such control of the cooling rate can promote the improvement in the particle strength of the granular PAS.

### Post-Treatment Step

The post-treatment step is a step of removing unnecessary components from the slurry obtained in the polymerization step to obtain the PAS. The post-treatment step in the method for producing PAS of an embodiment of the present invention is not limited as long as the step is a step typically used in the production of PAS.

After the completion of the polymerization reaction, a slurry containing the polymer (hereinafter, also referred to as “product slurry”) may be obtained by cooling the reaction mixture, for example. The cooled product slurry is separated by filtration as is or after diluted with water or the like, then washed and filtered repeatedly, and dried, whereby PAS can be recovered.

After various solid-liquid separation, the PAS may be washed with the organic amide solvent, which is the same as the polymerization solvent, or with an organic solvent, such as ketones (e.g., acetone) and alcohols (e.g., methanol). Furthermore, the PAS may be washed with high temperature water or the like. The produced PAS may be treated with acids or salts, such as ammonium chloride.

### II. Granular PAS

The granular PAS according to an embodiment of the present invention is obtained by the above-mentioned production method according to an embodiment of the present invention and has an average particle size of from 200 to 5000 μm, preferably from 300 to 3000 μm, and more preferably from 400 to 1000 μm and has a particle strength of 50% or more, preferably 65% or more, and more preferably 80% or more. In addition, the granular PAS according to an embodiment of the present invention is obtained by the above-mentioned production method according to an embodiment of the present invention, and thus the melt viscosity measured at a temperature of 310° C. and a shear rate of 1216 sec⁻¹ is from 1 to 30 Pa·s, preferably from 2 to 20 Pa·s, and more preferably from 3 to 15 Pa·s. The melt viscosity of the granular PAS can be measured at a predetermined temperature and shear rate condition using about 20 g of a dry polymer and using a capilograph. Thus, the granular PAS according to an embodiment of the present invention has high particle strength despite the low melt viscosity, and preferably further has a large average particle size.

In the present specification, the particle strength means a mass ratio calculated from B/A×100, in a state where, after 0.1 mass % of carbon black is added to 30 g of granular PAS (A) and the mixture is sieved with a 150 μm mesh sieve, granular PAS, from which fine powder is removed, is transferred to a 1 L of PP bottle, 500 g of glass beads are charged thereinto and crushed with a shaker at 300 rpm for 30 minutes, after the crushing, the granular PAS was sieved with a 2830 μm mesh sieve to remove the glass beads, the crushed fine powder is removed with a 150 μm mesh sieve, and the granular PAS (the mass is B) on the sieve is measured.

The PAS of an embodiment of the present invention, alone as it is or after oxidation crosslinking, can be formed into various injection molded articles or extrusion molded articles such as a sheet, a film, a fiber, and a pipe, by alone or selectively blending various inorganic fillers, fibrous fillers, and various synthetic resins.

In an embodiment of the present invention, the PAS is not particularly limited, and is preferably polyphenylene sulfide (PPS).

The present invention is not limited to the embodiments described above, and various modifications are possible within the scope indicated in the claims. Embodiments obtained by appropriately combining the technical means disclosed by the embodiments are also included in the technical scope of the present invention. In addition, all of the documents disclosed in the present specification are herein incorporated by reference.

### EXAMPLES

Embodiments of the present invention will be described in further detail hereinafter using examples. The present invention is not limited to the examples below, and it goes without saying that various aspects are possible with regard to the details thereof.

### (1) Melt Viscosity

The melt viscosity of the PAS was measured by Capirograph 1C (trade name) available from Toyo Seiki Seisaku-sho, Ltd. equipped with a nozzle of 1.0 mm in diameter and 10.0 mm in length as a capillary. The set temperature was 310° C. After the polymer sample was introduced into the apparatus and held for 5 minutes, the melt viscosity was measured at a shear rate of 1200 sec⁻¹.

### (2) Particle Strength

To 30 g of PAS (A), 0.1 mass % of carbon black was added, and the mixture was sieved with a 150 μm mesh sieve (initial fine powder removal). Thereafter, the sample, from which the fine powder was removed, was transferred to a 1 L of PP bottle, and 500 g of glass beads were charged thereinto and crushed with a shaker (Universal shaker AS-1N available from AS ONE Corporation) at 300 rpm for 30 minutes. After the crushing, the sample was sieved with a 2830 μm mesh sieve to remove the glass beads, the crushed fine powder was removed with a 150 μm mesh sieve, and the granular PAS (B) on the sieve was measured. The particle strength was calculated from B/A×100.

### (3) Average Particle Size

The average particle size of PAS was measured by using a sieving method in which sieves are used, the sieves having a sieve opening of 2800 μm (7 meshes (mesh count/inch)), a sieve opening of 1410 μm (12 meshes (mesh count/inch)), a sieve opening of 1000 μm (16 meshes (mesh count/inch)), a sieve opening of 710 μm (24 meshes (mesh count/inch)), a sieve opening of 500 μm (32 meshes (mesh count/inch)), a sieve opening of 250 μm (60 meshes (mesh count/inch)), a sieve opening of 150 μm (100 meshes (mesh count/inch), a sieve opening of 105 μm (145 meshes (mesh count/inch), a sieve opening of 75 μm (200 meshes (mesh count/inch), and a sieve opening of 38 μm (400 meshes (mesh count/inch)), and was calculated from masses of substances on each sieves when the cumulative mass is 50% by mass. The results are shown in Table 1.

### Example 1

### Dehydration Step

Into 20 L of autoclave, 6001 g of NMP, 2003 g of aqueous sodium hydrosulfide solution (NaSH: purity 61.64 mass %), and 1181 g of sodium hydroxide (NaOH: purity 73.04 mass %) were charged. After the inside of the autoclave was purged with nitrogen gas, the temperature of the inside of the autoclave was gradually increased to 200° C. while the inside of the autoclave was stirred by a stirrer at a rotational speed of 250 rpm over about 4 hours to distill off 1010 g of water (H₂O), 908 g of NMP, and 12 g of hydrogen sulfide (H₂S).

### First Polymerization Step

After the dehydration step, the contents of the autoclave were cooled to 150° C. and 3502 g of pDCB, 3028 g of NMP, 20 g of sodium hydroxide, and 143 g of water were added thereto, and the mixture was reacted at a temperature of 220° C. for 5 hours while stirred to perform first-stage polymerization. The ratio (g/mol) of NMP to a prepared sulfur source (hereinafter, abbreviated as “prepared S”) in a vessel was 375, pDCB/prepared S (mol/mol) was 1.100, and H₂O/prepared S (mol/mol) was 1.50. The conversion rate of pDCB in the first-stage polymerization was 93%.

### Phase Separation Agent Addition Step

After the completion of the first-stage polymerization, the rotational speed of the stirrer was increased to 400 rpm, and the contents of the autoclave was injected with 624 g of ion-exchanged water while stirred. The molar ratio of water with respect to the NMP in the phase separation agent addition step, that is, H₂O/NMP (mol/mol) in the phase separation agent addition step was 0.82.

### Second Polymerization Step

After the injection of ion-exchanged water, the temperature was increased to 255° C., and the reaction was performed for 4 hours to perform the second-stage polymerization step.

### Cooling Step

After the completion of the polymerization, the cooling was performed from 255° C. to 230° C. over 125 minutes, that is, the cooling rate from 255° C. to 230° C. was set to 0.2° C./min and then the quick cooling up to room temperature was performed.

### Post-Treatment Step

The 10% diluted pH of the obtained slurry was 10.1. The contents of the autoclave were sieved with a screen having an opening diameter of 150 μm (100 meshes), washed with acetone and ion-exchanged water, then washed with an aqueous acetic acid solution, and dried for 24 hours to obtain the granular PPS. The melt viscosity was 10 Pa·s, the particle strength was 91%, the average particle size was 573 and the yield was 88.0%.

### Example 2

Example 2 performed the same operation as in Example 1 except that the time to perform cooling from 255° C. to 230° C. was changed to 75 minutes, and the cooling rate was changed to 0.3° C./min. The melt viscosity was 9 Pa·s, the particle strength was 54%, the average particle size was 402 and the yield was 85.4%.

### Example 3

### Dehydration Step

Into 20 L of autoclave, 6002 g of NMP, 2003 g of aqueous sodium hydrosulfide solution (NaSH: purity 62.01 mass %), and 1180 g of sodium hydroxide (NaOH: purity 73.57 mass %) were charged. After the inside of the autoclave was purged with nitrogen gas, the temperature of the inside of the autoclave was gradually increased to 200° C. while the inside of the autoclave was stirred by a stirrer at a rotational speed of 250 rpm over about 2 hours to distill off 986 g of water (H₂O), 871 g of NMP, and 30 g of hydrogen sulfide (H₂S).

### First Polymerization Step

After the dehydration step, the contents of the autoclave were cooled to 150° C., 3506 g of pDCB, 3035 g of NMP, 22 g of sodium hydroxide, and 125 g of water were added to the autoclave, and the contents of the autoclave was continuously increased from 220° C. to 260° C. over 1.5 hours while stirred to perform the first-stage polymerization. The ratio (g/mol) of NMP to a prepared sulfur source (hereinafter, abbreviated as “prepared S”) in a vessel was 375, pDCB/prepared S (mol/mol) was 1.095, and H₂O/prepared S (mol/mol) was 1.50. The conversion rate of pDCB in the first-stage polymerization was 94%.

### Phase Separation Agent Addition Step

After the completion of the first-stage polymerization, the rotational speed of the stirrer was increased to 400 rpm, and the contents of the autoclave was injected with 588 g of ion-exchanged water while stirred. The molar ratio of water with respect to the NMP in the phase separation agent addition step, that is, H₂O/NMP (mol/mol) in the phase separation agent addition step was 0.79.

### Second Polymerization Step

After the injection of the ion-exchanged water, the temperature was increased to 265° C., and the reaction was performed for 2 hours to perform a second-stage polymerization.

### Cooling Step

After the completion of the polymerization, the cooling was performed from 265° C. to 230° C. over 102 minutes, that is, the cooling rate from 265° C. to 230° C. was set to 0.34° C./min and then the quick cooling up to room temperature was performed.

### Post-Treatment Step

The 10% diluted pH of the obtained slurry was 9.6. The contents of the autoclave were sieved with a screen having an opening diameter of 150 μm (100 meshes), washed with acetone and ion-exchanged water, then washed with an aqueous acetic acid solution, and dried for 24 hours to obtain the granular PPS. The melt viscosity was 11 Pa·s, the particle strength was 85.2%, the average particle size was 573 and the yield was 80.3%.

### Example 4

### Dehydration Step

Into 20 L of autoclave, 6000 g of NMP, 2001 g of aqueous sodium hydrosulfide solution (NaSH: purity 61.98 mass %), and 1201 g of sodium hydroxide (NaOH: purity 73.24 mass %) were charged. After the inside of the autoclave was purged with nitrogen gas, the temperature of the inside of the autoclave was gradually increased to 200° C. while the inside of the autoclave was stirred by a stirrer at a rotational speed of 250 rpm over about 2 hours to distill off 1024 g of water (H₂O), 654 g of NMP, and 28 g of hydrogen sulfide (H₂S).

### First Polymerization Step

After the dehydration step, the contents of the autoclave were cooled to 150° C., 3487 g of pDCB, 2815 g of NMP, 12 g of sodium hydroxide, and 158 g of water were added to the autoclave, and the contents of the autoclave was continuously increased in temperature from 220° C. to 260° C. over 1.5 hours while stirred to perform the first-stage polymerization. The ratio (g/mol) of NMP to a prepared sulfur source (hereinafter, abbreviated as “prepared S”) in a vessel was 375, pDCB/prepared S (mol/mol) was 1.090, and H₂/prepared S (mol/mol) was 1.50. The conversion rate of pDCB in the first-stage polymerization was 93%.

### Phase Separation Agent Addition Step

After the completion of the first-stage polymerization, the rotational speed of the stirrer was increased to 400 rpm, and the contents of the autoclave was injected with 627 g of ion-exchanged water while stirred. The molar ratio of water with respect to the NMP in the phase separation agent addition step, that is, H₂O/NMP (mol/mol) in the phase separation agent addition step was 0.82.

### Second Polymerization Step

After the injection of the ion-exchanged water, the temperature was increased to 260° C., and the reaction was performed for 2 hours to perform the second-stage polymerization.

### Cooling Step

After the completion of the polymerization, the cooling was performed from 260° C. to 230° C. over 102 minutes, that is, the cooling rate from 260° C. to 230° C. was set to 0.29° C./min and then the quick cooling up to room temperature was performed.

### Post-Treatment Step

The 10% diluted pH of the obtained slurry was 9.8. The contents of the autoclave were sieved with a screen having an opening diameter of 150 μm (100 meshes), washed with acetone and ion-exchanged water, then washed with an aqueous acetic acid solution, and dried for 24 hours to obtain the granular PPS. The melt viscosity was 12 Pa·s, the particle strength was 84.3%, the average particle size was 402 and the yield was 86.9%.

### Example 5

Example 5 performed the same operation as in Example 4 except that the amount of water added in the phase separation agent addition step was changed to 980 g and H₂O/NMP (mol/mol) in the phase separation agent addition step was changed to 1.06. The melt viscosity was 5 Pa·s, the particle strength was 81.8%, the average particle size was 437 μm, and the yield was 85.5%.

### Example 6

### Dehydration Step

Into 20 L of autoclave, 5999 g of NMP, 2001 g of aqueous sodium hydrosulfide solution (NaSH: purity 61.98 mass %), and 1210 g of sodium hydroxide (NaOH: purity 73.24 mass %) were charged. After the inside of the autoclave was purged with nitrogen gas, the temperature of the inside of the autoclave was gradually increased to 200° C. while the inside of the autoclave was stirred by a stirrer at a rotational speed of 250 rpm over about 2 hours to distill off 1042 g of water (H₂O), 651 g of NMP, and 28 g of hydrogen sulfide (H₂S).

### First Polymerization Step

After the dehydration step, the contents of the autoclave were cooled to 150° C., 3357 g of pDCB, 2808 g of NMP, 17 g of sodium hydroxide, and 173 g of water were added to the autoclave, and the contents of the autoclave was continuously increased in temperature from 220° C. to 260° C. over 1.5 hours while stirred to perform the first-stage polymerization. The ratio (g/mol) of NMP to a prepared sulfur source (hereinafter, abbreviated as “prepared S”) in a vessel was 375, pDCB/prepared S (mol/mol) was 1.070, and H₂O/prepared S (mol/mol) was 1.50. The conversion rate of pDCB in the first-stage polymerization was 93%.

### Phase Separation Agent Addition Step

After the first-stage polymerization step was completed, the rotation speed of the stirrer was increased to 400 rpm, and 443 g of ion-exchanged water was added to the autoclave while stirred. The molar ratio of water with respect to the NMP in the phase separation agent addition step, that is, H₂O/NMP (mol/mol) in the phase separating agent addition step was 0.70.

### Second Polymerization Step

After the injection of the ion-exchanged water, the temperature was increased to 265° C., and the reaction was performed for 2 hours to perform the second-stage polymerization.

### Cooling Step

After the completion of the polymerization, the cooling was performed from 265° C. to 230° C. over 102 minutes, that is, the cooling rate from 265° C. to 230° C. was set to 0.34° C./min and then the quick cooling up to room temperature was performed.

### Post-Treatment Step

The 10% diluted pH of the obtained slurry was 10.3. The contents of the autoclave were sieved with a screen having an opening diameter of 150 μm (100 meshes), washed with acetone and ion-exchanged water, then washed with an aqueous acetic acid solution, and dried for 24 hours to obtain the granular PPS. The melt viscosity was 27 Pa·s, the particle strength was 93.9%, the average particle size was 430 μm, and the yield was 87.6%.

### Example 7

Example 7 performed the same operation as in Example 6 except that the pDCB/prepared S (mol/mol) in a vessel in the first polymerization step was changed to 1.060. The melt viscosity was 22 Pa·s, the particle strength was 92.0%, the average particle size was 522 μm, and the yield was 84.9%.

### Example 8

Example 8 performed the same operation as in Example 6 except that the pDCB/prepared S (mol/mol) in a vessel in the first polymerization step was changed to 1.100. The melt viscosity was 8 Pa·s, the particle strength was 57.4%, the average particle size was 371 μm, and the yield was 82.0%.

Example 9

Example 9 performed the same operation as in Example 8 except that in the phase separation agent addition step, 90 g of sodium acetate (the amount of sodium acetate per 1 mol of prepared S in the phase separation agent addition step, that is, CH₃COONa/prepared S (mol/mol) in the phase separation agent addition step was 0.05) in addition to water as the phase separation agent was added. The melt viscosity was 9 Pa·s, the particle strength was 93.8%, the average particle size was 532 μm, and the yield was 80.6%.

### Comparative Example 1

Comparative Example 1 performed the same operation as in Example 1 except that the time to perform cooling from 255° C. to 230° C. was changed to 37 minutes, and the cooling rate was changed to 0.7° C./min. The melt viscosity was 11 Pa·s, the particle strength was 28%, the average particle size was 451 μm, and the yield was 84.0%.

### Comparative Example 2

Comparative Example 2 performed the same operation as in Comparative Example 1 except that the amount of water added in the phase separation agent addition step was changed to 441 g and H₂O/NMP (mol/mol) in the phase separation agent addition step was changed to 0.69. The melt viscosity was 11 Pa·s, the particle strength was 2.8%, the average particle size was 439 μm, and the yield was 78.3%.

TABLE 1

| | | | | | | | | | | Comparative | |
|---|---|---|---|---|---|---|---|---|---|---|---|
| | Examples | | | | | | | | | Examples | |
| | 1 | 2 | 3 | 4 | 5 | 6 | 7 | 8 | 9 | 1 | 2 |
| H₂O/NMP in phase | 0.82 | 0.82 | 0.79 | 0.82 | 1.06 | 0.70 | 0.70 | 0.70 | 0.70 | 0.82 | 0.69 |
| separation agent | | | | | | | | | | | |
| addition step | | | | | | | | | | | |
| (mol/mol) | | | | | | | | | | | |
| CH₃COONa/prepared | — | — | — | — | — | — | — | — | 0.05 | — | — |
| S in phase separation | | | | | | | | | | | |
| agent addition step | | | | | | | | | | | |
| (mol/mol) | | | | | | | | | | | |
| Cooling rate | 0.2 | 0.3 | 0.34 | 0.29 | 0.29 | 0.34 | 0.34 | 0.34 | 0.34 | 0.7 | 0.7 |
| (° C./min) | | | | | | | | | | | |
| pH of slurry after | 10.1 | 10.2 | 9.6 | 9.8 | 9.9 | 10.3 | 10.2 | 10.2 | 10.3 | 10.0 | 10.1 |
| polymerization | | | | | | | | | | | |
| Melt viscosity (Pa · s) | 10 | 9 | 11 | 12 | 5 | 27 | 22 | 8 | 9 | 11 | 11 |
| Particle strength (%) | 91 | 54 | 85.2 | 84.3 | 81.8 | 93.9 | 92.0 | 57.4 | 93.8 | 28 | 2.8 |
| Average particle size | 573 | 402 | 573 | 402 | 437 | 430 | 522 | 371 | 532 | 451 | 439 |
| (μm) | | | | | | | | | | | |
| Yield of granular | 88.0 | 85.4 | 80.3 | 86.9 | 85.5 | 87.6 | 84.9 | 82.0 | 80.6 | 84.0 | 78.3 |
| PPS (%) | | | | | | | | | | | |

As apparent from Table 1, according to the present invention, the granular PAS having high particle strength while having low melt viscosity can be produced.

1. A method for producing granular polyarylene sulfide having a melt viscosity of from 1 to 30 Pa·s, which is measured at a temperature of 310° C. and a shear rate of 1216 sec⁻¹, the method comprising:
a preparation step of preparing
a mixture containing an organic amide solvent, a sulfur source, water, a dihalo aromatic compound, and an alkali metal hydroxide;
a first polymerization step of initiating a polymerization reaction by heating the mixture and generating a reaction mixture containing a prepolymer having a conversion rate of the dihalo aromatic compound of from 50 to 98 mol %;
a phase separation agent addition step of adding a phase separation agent to the reaction mixture after the first polymerization step;
a second polymerization step of continuing the polymerization reaction after the phase separation agent addition step; and
a cooling step of cooling the reaction mixture after the second polymerization step,
wherein the phase separation agent includes water;
a molar ratio of the dihalo aromatic compound with respect to the sulfur source in the preparation step is from 1.09 to 1.100;
a molar ratio of water to the organic amide solvent in the phase separation agent addition step is from 0.70 to 3.0;
the polymerization reaction in the second polymerization step is performed in a range of from 245 to 290° C.; and
a cooling rate in the cooling step is 0.35° C./min or less.

2. The method according to claim 1, wherein a pH of the reaction mixture after the second polymerization step is set to from 8 to 11.

3. The method according to claim 1, wherein the phase separation agent is a mixture containing an alkali metal carboxylate and water.

4. (canceled)
